(19) United States
(12) Patent Application Publication
(10) Pub. No.: US 2012/0175974 A1
(43) Pub. Date: Jul. 12, 2012

(54) COMPACT ELECTROMECHANICAL MECHANISM AND DEVICES INCORPORATING THE SAME

(76) Inventor: Glen A. Robertson, Madison, AL (US)

(21) Appl. No.: 12/987,344

(22) Filed: Jan. 10, 2011

(51) Int. Cl. H02K 41/035

(52) U.S. Cl. 310/12.26

(57) ABSTRACT

An improvement on the compact electromechanical mechanism of patent application Ser. No. 29/364,177 composed of a divergent flux path electromagnetic device includes dual magnetic flux paths from a radially poled permanent magnet along parallel and coaxially pole pieces so as the magnetic flux is diverted in a single direction by a pair of control coils wound coaxially on each magnet flux path about the center pole piece and adjacent to the radially poled permanent magnet. The control coils may be energized in a variety of ways to achieved desirable linear or bi-linear motion for various linear motion and linear reciprocating devices.

### FIELD OF THE INVENTION

The present invention relates to an improvement of patent application Ser. No. 29/364,177, in general, to an electromechanical mechanism composed of a dual magnetic flux path electromagnetic device wherein the magnetic flux from a radially poled permanent magnet with extended coaxial pole pieces is directionally induced to change paths by control coils placed about the center pole pieces in order to magnetically attract end plates for the purpose of producing mechanical force. Such electromechanical mechanism may take on a variety of configurations facilitating use of such components in a variety of applications including applications involving the production of linear and linear reciprocating motion. Several novel electromagnetic devices of actuator constructions, which operate by diverting the path of magnetic flux from a radial poled permanent magnet, are described, such actuator constructions having increased efficiency and more desirable characteristics to include compactness and increased efficiency as compared to prior art.

### BACKGROUND OF THE INVENTION

Magnetic force of attraction is commonly used in a variety of electromechanical mechanisms. In the field of such electromechanical mechanisms there is a continuous pursuit of increased efficiency, reduced complexity and compactness. Accordingly, the present invention provides an electromechanical mechanism requiring less input energy and reduced complexity through the inclusion of an electromagnetic device composed of a radially poled permanent magnet with extended coaxial pole pieces and coaxially wound control coils to form a more compact electromechanical mechanism.

The prior art has provided electromechanical mechanisms using dual path permanent magnets (for example U.S. Pat. No. 6,246,561), but such a device typically is not compact, needs higher external energy to energize the control coils, produces lower magnetic forces for the same footprint compared to the present invention and have not seen much use in electromechanical mechanisms.

### SUMMARY OF THE INVENTION

It is an object of the present invention to provide an economical, pollution-free electromechanical mechanism which may be used for a wide variety of applications, requiring less input energy than prior art.

It is another object of the invention to provide a lightweight electromechanical mechanism utilizing permanent magnets for producing high mechanical force with reduced input energy and small foot print.

It is another object of the invention to provide an electromechanical mechanism utilizing permanent magnets in conjunction with other force mechanisms for producing mechanical force with reduced input energy over large linear and bi-linear distances with improved operating characteristics.

These and other objects of the invention are attained by an electromechanical mechanism containing an electromagnetic device which, in one aspect, is a divergent flux path permanent magnet device, comprising a radially poled permanent magnet having concentric magnet pole faces, an inner pole piece positioned centered in the center of the radially poled permanent magnet, an outer perimeter pole piece positioned centered about the outer perimeter of the radial poled permanent magnet, control coils wound coaxially with the center pole piece, and circuit means, each magnet flux path follows a path from the radially poled permanent magnet through the center pole piece bi-directionally to the outer perimeter pole piece and back to the radially poled permanent magnet. The pair of control coils are positioned around the center pole piece on either side of the radially poled permanent magnet, the circuit means is connected to the pair of control coils, energized alternately in a timed sequential manner to produce linear or bi-linear magnetic force on magnetically attractive materials or end plates placed on one or both sides of the invention to form an electromechanical mechanism. Single directionality of the end plates are accomplished by energizing the pair of control coils in like current direction, diverting the permanent magnet-magnetic flux along a path to one side of the permanent magnet as defined by the direction of the control coils' magnetic flux which couples to the magnetic flux of the permanent magnet; reversing the current directions in sequence produces the opposite effect.

### BRIEF DESCRIPTION OF THE DRAWINGS

For a better understanding of the present invention, reference maybe made to the accompanying drawings in which:

FIG. 1 is a perspective view of one embodiment of an electromagnetic device in accordance with the present invention based on a toroid shaped permanent magnet;

FIG. 2 is a cross-sectional view of FIG. 1 showing the two magnetic flux paths;

FIG. 3 is a perspective view of a circuit to control one direction of the current in the control coils with the control coils wound to produce the same directionality of the current and magnetic flux direction as represented by the arrow;

FIG. 4 is a perspective view of a circuit to control the direction of the current in the control coils opposite to FIG. 3;

FIG. 5 is a cross-sectional view of one embodiment of an electromagnetic device with free moving magnetically attractive end plates and energized control coils per FIG. 3, in which the two coupled magnetic fluxes from the permanent magnet (bold arrows) and control coils (light arrows) traverses a single path closed by a magnetically attractive end plate to produce a strong coupling force between the pole pieces and the end plate;

FIG. 6 is a perspective view of one embodiment of the electromagnetic device in FIG. 2 with non-energized control coils, in which, the majority of the permanent magnet's magnetic flux (light arrows) remains on the single closed path by the magnetically attractive end plate to maintain a slightly reduced coupling force from FIG. 5 due to some leakage magnetic flux (dotted arrows) along the second open path toward the other magnetically attractive end plate as a result of the non-energized control coils not producing parallel magnetic flux to overcome the leakage magnetic flux of the permanent magnet;

FIG. 7 is the embodiment of FIG. 5 with the control coils oppositely energized per FIG. 4;

FIG. 8 is the embodiment of FIG. 7 with the controls non-energized, in like to FIG. 6;

FIG. 9 is a cross-sectional view of one embodiment incorporating the present invention to close a valve;

FIG. 10 is a cross-sectional view of the embodiment in FIG. 9 activated in the opposite direction to open the valve;

FIG. 11 is a cross-sectional view of one embodiment of a reciprocating pump incorporating the present invention to move pistons for fluid compression;

FIG. 12 is a cross-sectional view of the reciprocating pump of FIG. 11 activated in the opposite direction;

FIG. 13 is a cross-sectional view of one embodiment of a simple electrical relay incorporating the present invention to de-activate an electrical circuit;

FIG. 14 shows the simple electrical relay of FIG. 13 activated in the opposite direction to activate an electrical circuit;

FIG. 15 shows a cross-sectional view of one embodiment of a pulsed tube cooler incorporating the present invention to pulse a gas through the system;

FIG. 16 shows the pulsed tube cooler of FIG. 15 activated in the opposite direction.

FIGS. 17-20 show a cross-sectional view of one embodiment of a simple actuator incorporating the present invention to illustrate multiple staging;

FIG. 17 shows a cross-sectional view of the multiple stage actuator with activation or latching in one direction (right);

FIG. 18 shows a cross-sectional view of the multiple stage actuator with individual components activated to produce motion in one direction (left);

FIG. 19 shows a cross-sectional view of the multiple stage actuator with further individually components activation to produce continued motion in the same direction (left) as in FIG. 18;

FIG. 20 shows the multiple stage actuator of FIG. 17 with activation or latching in the opposite direction (left) after multi-staging the components.

### DETAILED DESCRIPTION OF THE INVENTION

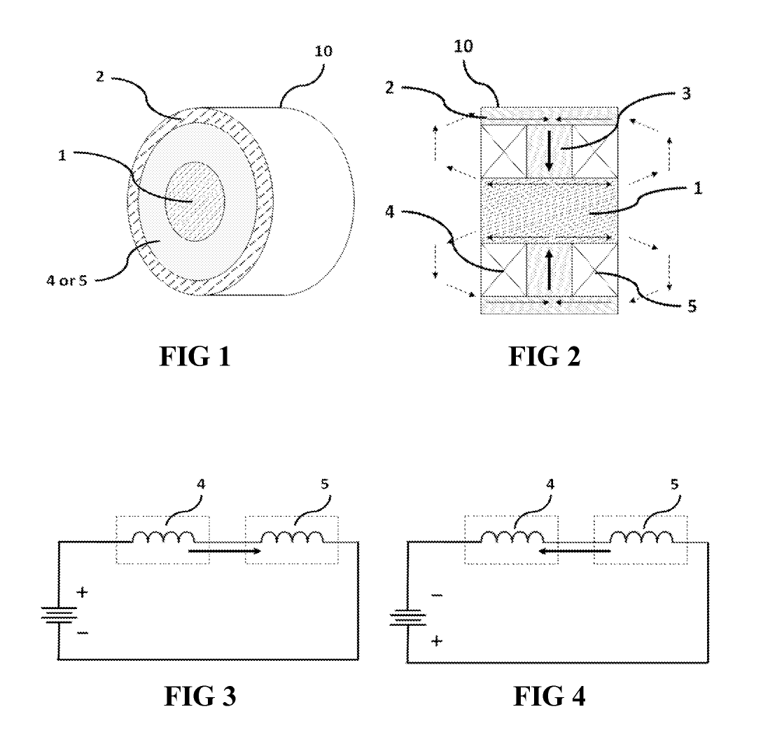

Referring now to the drawings, FIGS. 1-2 are provided to facilitate an understanding of various aspects or features of the technology utilized in the present invention. It is understood that multiple shapes and sizes are attainable using different shape and size radial poled permanent magnets 3 as toroid, square, rectangle or other geometric shapes with design suited for the present invention. The radially poled permanent magnet 3 may be solid or segmented and composed of any desirable permanent magnet material giving the desirable magnetic field and force characteristics needed for a given application. Multiple shapes and sizes of the permanent magnet are attainable using different shape and size permanent magnets as toroid, square, rectangle or other geometric shapes that can be either one piece or composed of multiple pieces in a solid of segmented form. Regardless of the shape and size permanent magnet, the radial poling direction of the permanent magnet can be either: north outward—south inward or south outward—north inward from a defined center of the permanent magnet.

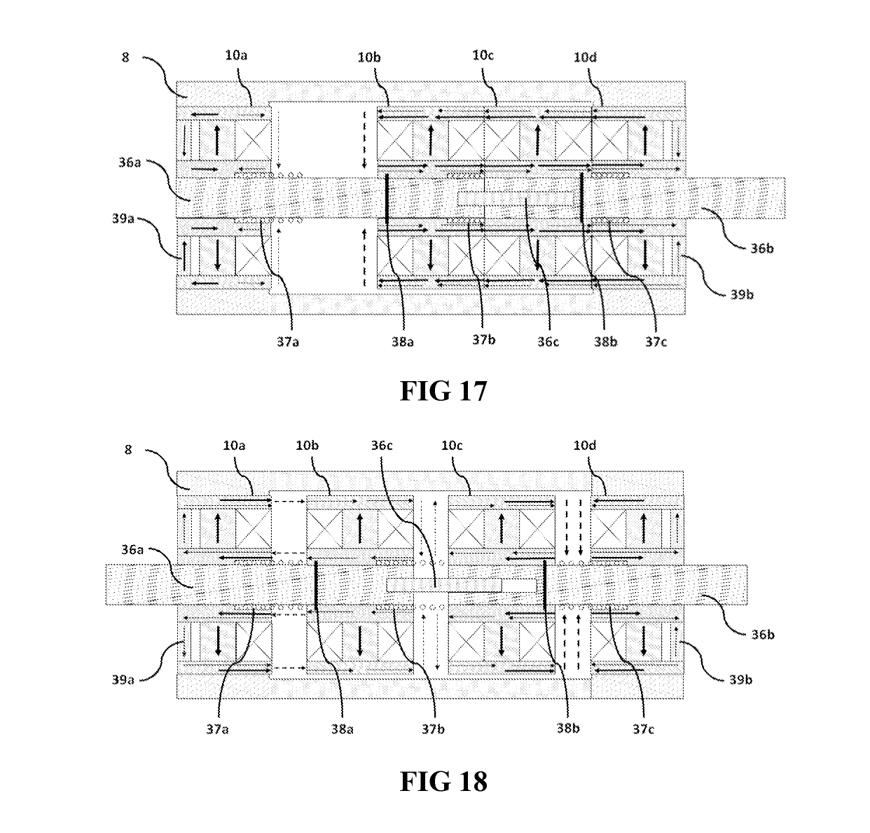

FIG. 1-2 depicts the preferred form of the invention as used throughout this specification, the permanent magnet 3 has a flat toroid shape and is poled radially with north inward of the toroid, allowing for an electromechanical device 10 that is cylindrical in shape to produce a more compact and functional design over the prior art of U.S. Pat. No. 6,246,561, which:
(a) Through the center circular bore pole face and about the perimeter of the outer circular pole face of the toroid permanent magnet 3 are placed parallel pole pieces 1 and 2 extending away from the toroid permanent magnet 3 in a bi-directional coaxial form.
(b) The pole pieces 1 and 2, regardless of the shape or size, the preferably formed of soft iron, steel or some other magnetic material, with the preferred material being one which provides low reluctance, exhibits low hysterisis, and has a high magnetic flux density capability; likewise could be of laminate type construction; and
(c) Around the center pole piece 1, on at least one side and adjacent to the toroid permanent magnet 3 is placed control coil 4 or 5; in the preferred form as shown throughout this specification except in FIGS. 17-20, both control coils 4 and 5 are used and wound in like direction as to form a single solenoid design about the center pole piece.

In FIG. 2, the permanent magnet 3 is poled north inward—south outward with the south to north direction given by the direction of the dark arrow. As shown, the magnetic flux follows a radial path through the toroid permanent magnet 3, bi-directionally (light arrows) through the tubular pole piece 2, outward (dash arrows) into the surroundings bending back into each end of the center rod shaped pole piece 1, returning (light arrows) to the inner bore of the permanent magnet 3. As used throughout this specification it is understood that leakage magnetic flux from the various components is disregarded for simplicity, but may need to be understood in various designs using the present invention.

FIGS. 3-4 are provided to give perspective views of a circuit to control the current in the control coils 4 and 5 of the compact electromagnetic device 10 in FIG. 1-2. As shown in FIG. 3, the power supply represented by the battery symbol with positive (+) pole and negative (−) pole will drive the current in the control coils in opposite direction to FIG. 4. In FIGS. 3-4, the control coils 4 and 5 are energized with the same electrical power with opposite current direction as represented by the bold arrows. In the preferred form of the technology:
(a) the control coil pairs 4 o and 5, as pairs, form unit solenoids with the magnetic field produce in each pair being of the same magnitude and direction; and with
(b) all control coils placed in the device with windings in the same direction.

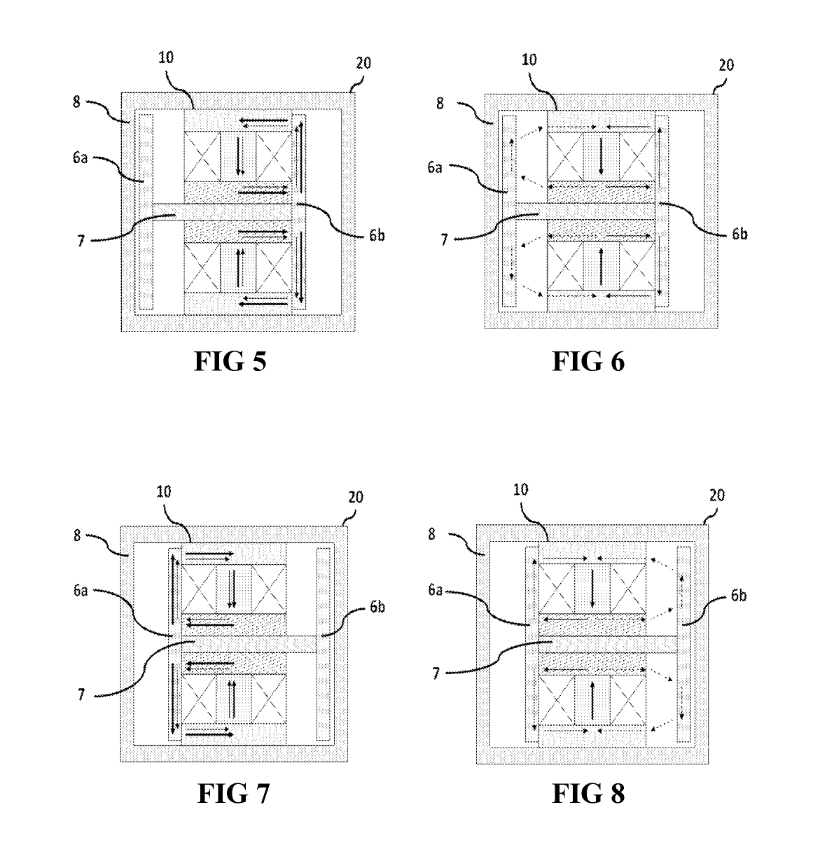

FIGS. 5-8 are provided to facilitate an understanding of the magnetic force feature of the compact electromechanical mechanism 20 composed of the electromagnetic device 10 of FIG. 1-2 with the addition of magnetically attractive end plates 6a and 6b connected by the member 7 and a surrounding housing unit 8 firmly connected to the electromagnetic device 10.

In FIG. 5-8, the magnetic force generated by the compact electromagnetic device 10 is shown to act on magnetically attractive end plates 6a and 6b, solidly connected by an attachment 7 free to move in a bore cut through the center pole piece of the compact electromagnetic device 10, which:
(a) The end plates 6a and 6b, regardless of the shape or size, the preferably formed of soft iron, steel or some other magnetic material, with the preferred material being one which provides low reluctance, exhibits low hysterisis, and has a high magnetic flux density capability; likewise could be of laminate type construction;
(b) The attachment 7, regardless of the shape or size, the preferred formed of aluminum, brass, non-magnetic stainless steel or some other non-magnetic material, with the preferred material being one which provides no attractive magnetic force and strength as required for the intended use;
(c) The preferred mating surfaces of the end plates 6a and 6b, and the end faces of the pole pieces of the compact electromagnetic device 10 are parallel to optimize the attractive magnetic force between them; and
(d) Sequentially alternating and timed activation of the circuits of FIGS. 3-4 produces a sequentially alternating and timed reversal of the magnetic flux in the pole pieces of the compact electromagnetic device 10, alternating the magnetic attraction on the end plates 6a and 6b from one side to the other.

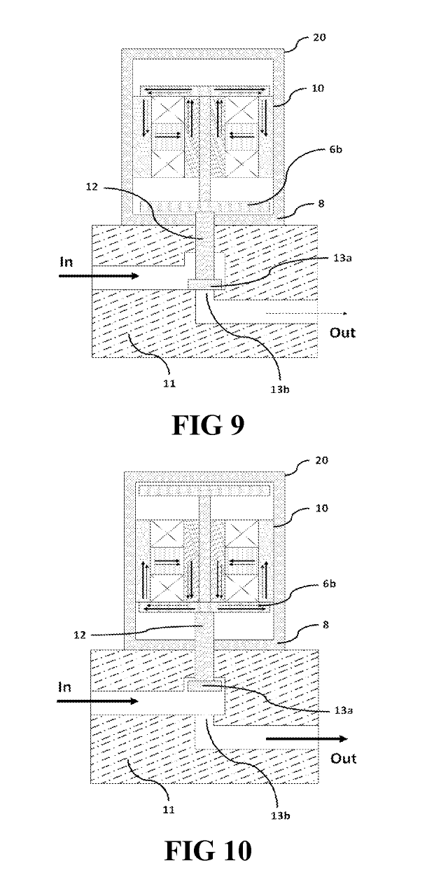

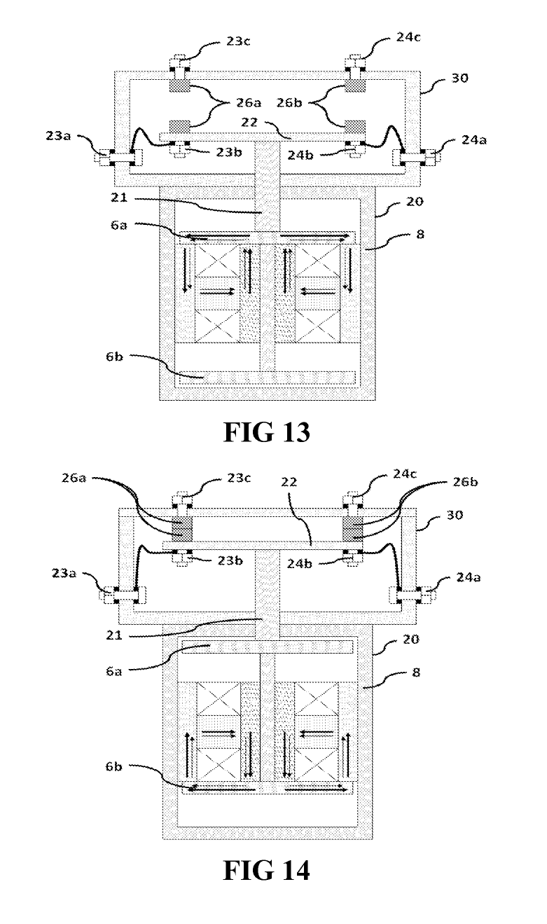

In FIGS. 5-8, the sequentially alternating and timed activation of the control coils of the compact electromagnetic device 10 by the circuits of FIGS. 3-4 provides for energy savings as the length of activation need only provide release and acceleration of the end plates at which time the electrical power (batteries) to the circuit of FIGS. 3-4 can be removed. As example, in applications were an electromechanical mechanism requires a solenoid to remain in one direction as with a valve (FIGS. 9-10) or relay (FIGS. 13-14) needed to remain open or closed, the total energy E in watt-hours is given by the equation

E=∫Pdt=IV·t

where P=IV is the power in watts, I is the current in amps, V is the voltage in volts, and t is the time in hours the device is under power. For I=5 amps, V=20 volts and t=(2 min/60 min) hours 0.033 hours for a total energy of E˜3.33 watt-hours. For the present invention to achieve the same results, it must first be activated in one direction and then the other which gives the total energy by equation

E=∫Pdt=IV·2t_{PI}

where t_{PI} is the activation time of the device in either direction. For the present invention the activation time to achieve the proper acceleration would be in the milli-seconds or say t_{PI}˜(0.001 sec/60 sec) min=0.0000166 min or t_{PI}˜0.000000277 hours to give the total energy, required to move the attractive plate in first one direction and then the other with the same power P requirement, asE˜0.0000554 watt-hours, roughly five orders of magnitude smaller representing a signification energy savings.

In FIG. 5 the permanent magnet is poled per FIG. 2 with direction given by the arrows and the control coils are under electrical power per FIG. 3 or FIG. 4. As shown, the bi-direction of the permanent magnet flux of FIG. 2 is diverted (bold arrows) in the direction of the control coils magnetic flux (light arrows) which results in a force related to the coupling of the magnetic flux from the control coils and permanent magnet of the compact electromagnetic device 10, which tends to hold the end plate 6b in position adjacent to the end faces of pole pieces on the corresponding side of the compact electromagnetic device 10.

FIG. 6 shows the compact electromagnetic mechanism 20 of FIG. 5 with the control coils of the compact electromagnetic device 10 non-energized or not under any electrical power. As shown, the attractive plate 6b remains against the adjacent end faces of pole pieces of the compact electromagnetic device 10 due to the higher magnetic flux (light arrows) closing the magnetic path or circuit through the end plate 6b. The dotted arrows represent the lower magnetic flux allowed to relax, bi-directionally per FIG. 2 due to the removal of the current in the control coils of the compact electromagnetic device 10.

FIGS. 7-8 show the opposite effect of energizing the control coils of the compact electromagnetic device 10 in FIG. 7 per FIG. 4 or FIG. 3 dependent on the winding direction of the control coils and then non-energizing the control coils of the compact electromagnetic device 10 in FIG. 8.

FIGS. 9-20 are given to show various generalized applications of the present invention where the detailed operation of such devices are found elsewhere. In FIGS. 9-20, each of the applications only represents one of many variations that can be developed using the present invention. It is understood that many version of such devices and other devices incorporating the present invention can be produced.

### Additional Force Mechanism

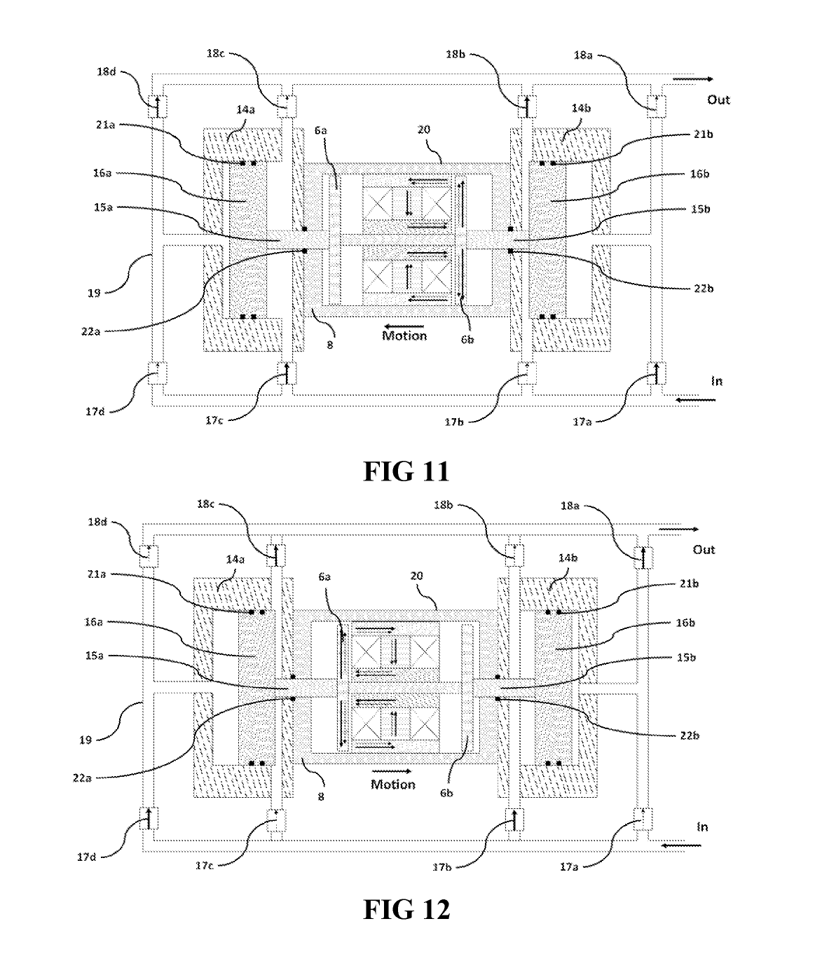

The present invention can be enhanced for greater linear motion with electrical efficiency through the adaptation of other force mechanisms that do not require electrical power. Additional force mechanisms are demonstrate in FIGS. 11-14, where the input fluid pressure aid in compressing the output fluid, and in FIGS. 17-20, where springs are use to aid in the motion of the actuator, noting other non-electrical force mechanisms and methods can be used to enhance efficiency.

### Flow Valve

FIGS. 9-10 show a simple flow valve incorporating the compact electromechanical mechanism 20 connected to a flow body 11, appropriately designed to for gas or liquid flow and incorporating an in and out flow path as indicated by the (In and Out) arrows, a value stem 12, a valve seat 13 with portion 13a connected to the valve stem 12 and portion 13b as part of the flow body 11 to create a firm seal when connected. The valve stem 12, regardless of the shape, size or material composition, is connected to the end plates 6b of the compact electromagnetic mechanism 20, passing through the housing 8. FIG. 9 shows the valve seat portion 13a closed against the valve seat portion 13b and FIG. 10 shows the valve seat portion 13a open or lifted off the valve seat portion 13b. As used in FIGS. 9-10, it is understood that:
(a) The compact electromagnetic mechanism 20 is shown with the electrical power on to the respective control coils per FIGS. 5 and 7, respectively. If appropriately designed with the proper magnetic holding force, the power may be turned off to conserve electrical energy as noted by FIGS. 6 and 8, respectively.
(b) The circuits of FIG. 3 or FIG. 4 are used to open or close the valve seat portion 13a against the valve seat portion 13b and FIG. 10 the reverse circuit of FIG. 4 or FIG. 3 to open or lift the valve seat portion 13a off the valve seat portion 13b.
(c) The arrows represent flow or pressure.

### Pump

FIGS. 11-12 show a simple pump incorporating the compact electromechanical mechanism 20 to illustrate reciprocating motion. The compact electromechanical mechanism 20 through the housing 8 is connected to pump housings 14a and 14b, appropriately designed to for gas or liquid flow and incorporating in and out flow paths 19 with input check valves 17a, 17b, 17c and 17d and output check valves 18a, 18b, 18c and 18d, a connection members 15a and 15b, and pistons 16a and 16b. The connection members 15a and 15b, regardless of the shape, size or material composition, is connected to the end plates 6a and 6b of the compact electromagnetic mechanism 20, passing through the housing 8a. FIG. 11 shows the piston 16a moving to the left and FIG. 12 shows the piston 16b moving to the right. As used in FIGS. 9-10, it is understood that:
(a) The circuits of FIG. 3 or FIG. 4 are used to move the piston to the left or right.
(b) The compact electromagnetic mechanism 20 is shown with the electrical power on to the respective control coils per FIGS. 5 and 7, respectively.
(c) The arrows represent in and out flow.
(d) Flow through the input check valves 17a, 17b, 17c and 17d, and output check valves 18a, 18b, 18c and 18d are indicated by bold arrows and restricted or non-flow is indicated by the dashed arrow.
(e) Regardless of directional motion of the end plates 6a and 6b of the compact electromechanical mechanism 20, input and output flow is in the same direction with higher pressure due to the pumping action during operation.

### Electrical Relay

FIGS. 13-14 show a simple electrical relay incorporating the compact electromechanical mechanism 20 to illustrate utility for remote operation of devices in similar manner. The compact electromechanical mechanism 20 is firmly connected through the housing 8 to a non-electrical conductive relay housing 20 containing input terminals 23a and 24a and output terminals 23c and 24c. Connection terminals 23b and 24b are mounted on a non-electrically conductive plate 22 and connected to input terminals 23a and 24a through wires to allow movement of the plate 22 firmly connected to the connection members 21. The connection members 21, regardless of the shape, size or material composition is connected to the end plate 6a of the compact electromagnetic mechanism 20, passing through the housings 8 and 30. FIG. 13 shows the relay open and FIG. 14 shows the relay closed by the contact of the paired electrodes 26a and 26b. As used in FIGS. 13-14, it is understood that:
(a) The circuits of FIG. 3 or FIG. 4 are used to move the piston to the left or right.
(d) The compact electromagnetic mechanism 20 is shown with the electrical power on to the respective control coils per FIGS. 5 and 7, respectively. If appropriately designed with the proper magnetic holding force, the power may be turned off to conserve electrical energy as noted by FIGS. 6 and 8, respectively.

### Pulse Tube Cryo-Cooler

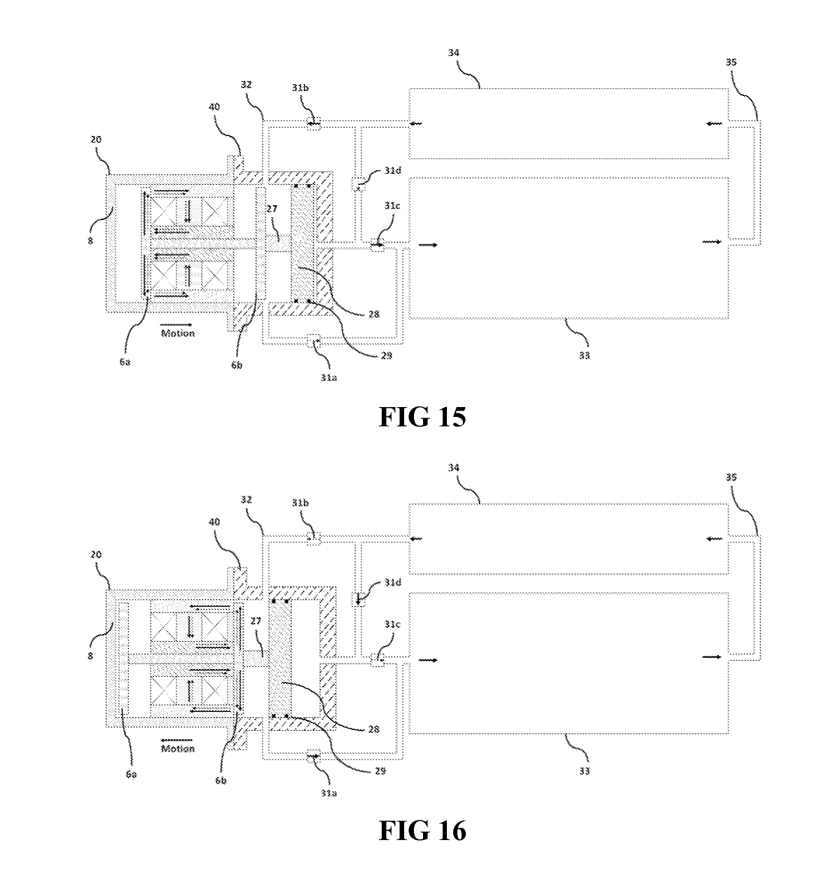

FIGS. 15 and 16 show a simple pulsed tube refrigerator (U.S. Pat. No. 3,237,421, U.S. Pat. No. 3,817,044, U.S. Pat. No. 5,295,355, U.S. Pat. No. 7,131,276) incorporating the compact electromechanical mechanism 20 to compress a gas through a regenerator 33, cold head 35 and pulse tube 34 through check valves 31a, 31b, 31c and 31d in a proper order to allow flow through the refrigerator in a single direction, regardless of the direction of the electrical power applied to the compact electromechanical mechanism 20, with the chambers on either side of the compression piston 28 acting as both a compressor and reservoir. The compressor section is composed of a housing 40 containing a connection member 27 firmly attached to the end plate 6b and compression piston 28 having o-ring seals 29. FIG. 15 shows the piston 16a moving to the right and FIG. 16 shows the piston 16b moving to the left. As used in FIGS. 15 and 16, it is understood that:

(b) The circuits of FIG. 3 or FIG. 4 are used to move the piston to the left or right.

(e) The compact electromagnetic mechanism 20 is shown with the electrical power on to the respective control coils per FIGS. 5 and 7, respectively. If appropriately designed with the proper magnetic force, the power may be turned off between pulses to conserve electrical energy as noted by FIGS. 6 and 8, respectively.

### Multi-Stage Actuator

FIGS. 17-20 show a simple actuator incorporating the present invention to illustrate multiple staging of several compact electromagnetic devices 10 in a single unit and is composed of the compact electromagnetic devices 10a and 10d with single control coils and compact electromagnetic devices 10b and 10c with unit control coil pairs wound in like direction, an outer housing 8, a three piece actuator shaft 36a, 36b and 36c with piece 36c firmly connect to piece 36a and with pieces 36a and 36b connected to the compact electromagnetic devices 10b and 10c by connection pieces 38a and 38b, toroid magnetic flux path pieces 39a and 39b, and force mechanisms or springs 37a, 37b and 37c. The actuator shaft member 36c is an aid to keep the actuator shaft pieces 36a and 36b aligned.

FIG. 17 shows the simple actuator with control coils in the compact electromagnetic devices 10a under no electrical power and in the compact electromagnetic devices 10b, 10c, and 10d under electrical power using FIG. 3 or FIG. 4 dependent on direction of the coil windings to produce a single magnetic flux path defined by the arrows, where the bold arrows represent the magnetic flux of and from the permanent magnet, the light arrows represent the magnetic flux of the control coils and the dash arrows represent the magnetic flux path from the compact electromagnetic devices 10b, 10c, and 10d emitted between the inner and outer pole pieces of the compact electromagnetic devices 10b. As shown in FIG. 17,
(a) the magnetic circuit defined by the arrows through the compact electromagnetic devices 10b, 10c, and 10d magnetically holds these devices along with the actuator shaft members 36a, 36b and 36c (through connection members 38a and 38b) together to one side of the actuator while compressing springs 37b and 37c; and
(b) the magnetic circuit defined by the arrows through the compact electromagnetic devices 10a and toroid magnetic flux path pieces 39a produces very little leakage magnetic flux (dotted arrow), which could interact with the magnetic flux from the compact electromagnetic device 10b. Whereby, the compact electromagnetic devices 10a and 10b remain apart.

FIG. 18 shows the simple actuator of FIG. 17 with the control coils in the compact electromagnetic devices 10a, 10c, and 10d under electrical power using FIG. 3 or FIG. 4 dependent on direction of the coil windings and the control coils in the compact electromagnetic devices 10a and 10c energized opposite to the compact electromagnetic device 10d. As shown in FIG. 18,
(a) the magnetic flux (dash arrows) between the compact electromagnetic devices 10c and 10d are opposing, which forces the compact electromagnetic devices 10c and 10d apart aided by the force mechanism or spring 37c carrying the actuator shaft member 36b with it through the connection piece 38b;
(b) the magnetic flux (dash arrows) between the compact electromagnetic devices 10b and 10c are not opposing, which allows the force mechanism or spring 37b to forces the compact electromagnetic devices 10b and 10c apart carrying the actuator shaft member 36a and 36c with it through the connection piece 38a;
(c) the actuator shaft member 36c, firmly attached to actuator shaft member 36a, moves within actuator shaft member 36b to aid the alignment between the actuator shaft pieces 36a and 36b;
(d) the magnetic flux (dash arrows) between the compact electromagnetic devices 10a and 10b are attractive, which forces the compact electromagnetic devices 10c and 10d toward each other;

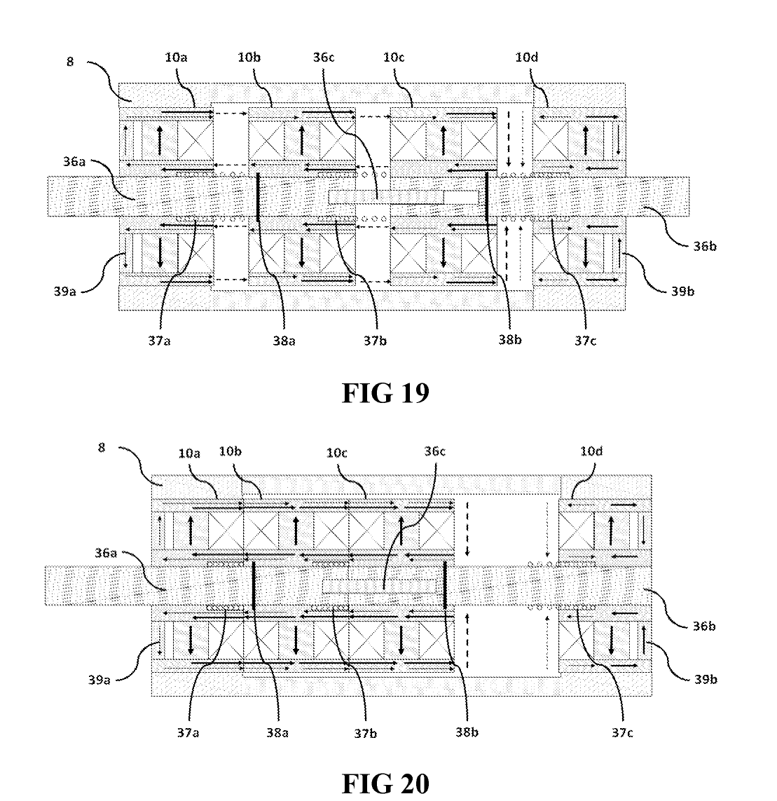

FIG. 19 shows the simple actuator of FIG. 18 with the control coils in the compact electromagnetic device 10ae energized opposite from that of FIG. 17 and compact electromagnetic device 10d non-energized. Whereby, the compact electromagnetic devices 10a, 10b, and 10c are attractive and compact electromagnetic devices 10c and 10d slightly opposing aided by the force mechanism or spring 37c.

FIG. 20 shows the simple actuator of FIG. 19 with control coils in the compact electromagnetic devices 10a, 10b, and 10c under electrical power using FIG. 3 or FIG. 4 dependent on direction of the coil windings to produce a single magnetic flux path defined by the arrows, where the bold arrows represent the magnetic flux of and from the permanent magnet, the light arrows represent the magnetic flux of the control coils and the dash arrows represent the magnetic flux path from the compact electromagnetic device 10c emitted between the inner and outer pole pieces of the compact electromagnetic devices 10c. As shown in FIG. 20,
(c) the magnetic circuit defined by the arrows through the compact electromagnetic devices 10a, 10b, and 10c magnetically holds these devices along with the actuator shaft members 36a, 36b and 36c (through connection members 38a and 38b) together to one side of the actuator while compressing springs 37a and 37b;
(d) the magnetic circuit defined by the arrows through the compact electromagnetic devices 10d and toroid magnetic flux path pieces 39b produces very little leakage magnetic flux, which could interact with the magnetic flux from the compact electromagnetic device 10c. Whereby, the compact electromagnetic devices 10c and 10d remain apart; and
(e) during the motion process the actuator shaft member 36c, firmly attached to actuator shaft member 36a, moves within actuator shaft member 36b to aid the alignment between the actuator shaft pieces 36a and 36b.

What is claimed is:

1. An electromagnetic device, comprising a permanent magnet having a radially poled north and south pole faces, a center pole piece, an outer pole piece, a control coil or pair of control coils acting as one unit, and controlling circuit,
(a) the center pole piece positioned-centered and adjacent the center bore of the permanent magnet forming a first perpendicular dual magnetic flux path portion—extending parallel and bi-directionally from the center of the permanent magnet,
(b) the outer pole piece positioned-centered and adjacent around the outer pole face of the permanent magnet forming a second perpendicular dual magnetic flux path portion—extending parallel as to be co-axial and of equal length to the center pole piece and bi-directionally from the outer pole face of the permanent magnet,
(c) a single control coil positioned around the center pole piece on either side of the permanent magnet or a unit control coil pair positioned around the center pole piece one on either side of the permanent magnet,
(d) the circuit connected to the control coil or unit control coil pair to energize the control coil in the proper direction and in a manner to produce a single directionality and magnetic circuit in either of the dual magnetic flux path portions alternately to one side or the other of the electromagnetic device.

2. A method for controlling the path of magnetic flux from a radially poled permanent magnet, the method comprising the steps of:
(a) placing a center pole piece through and adjacent the central bore pole face of the radially poled permanent magnet so as to have dual magnetic flux path portions extending bi-directionally and perpendicular beyond a perimeter of the central bore pole face;
(b) placing a pole piece about and adjacent the outward pole face of the radial poled permanent magnet aligned parallel with the center pole piece so as to have dual magnetic flux path portions extending bi-directionally and perpendicular beyond a perimeter of the outward pole face; and
(c) placing a control coil adjacent to the radially poled permanent magnet about one magnetic flux path portions of the center pole piece as not to extend beyond the ends of the center pole piece; or a unit control coil pair one around each magnetic flux path portions of the center pole piece adjacent the radially poled permanent magnet as not to extend beyond the ends of the center pole piece, forming a single solenoid design when energized.

3. A method for magnetically attracting end plates from a radially poled permanent magnet, the method comprising the steps of:
(a) placing magnetically attractive end plates adjacent to one or both sides of the electromagnetic device in claim 1;
(b) controlling the magnetic flux path from the radially poled permanent magnet in claim 2 to attract one of the end plates to one side or the other of the electromagnetic device.

4. The permanent magnet in claim 1-2 being of single piece or segmented.

5. The permanent magnet in claim 1-2 being poled either north inward-south outward or south inward-north outward.

6. The pole pieces in claim 1-2 being of single piece or segmented.

7. The pole pieces in claim 1-2 being solid or tubular.

8. The attractive end plates in claim 3 being of single piece or segmented.

9. The electromagnet device as set forth in claim 1, wherein the control coil pair are simultaneously energized in a permanent magnet magnetic flux diverting and single directionality manner.

10. The electromagnetic device as set forth in claim 1, wherein the open magnetic circuit can form a closed magnetic circuit by a magnetically attractive plate placed across the center pole piece and the segmented or tubular pole piece, whereby the magnetic flux produces a force on the attractive plate.

11. The electromagnet device as set forth in claim 1, wherein the control coil or unit control coil pair is simultaneously and alternately energized in a permanent magnet magnetic flux diverting and single alternating directionality manner.

12. The electromagnetic device as set forth in claim 1, wherein the control coil or unit control coil pair is energized alternately in a timed sequential manner to alternately produce a single directionality and open magnetic circuit in either of the dual magnetic flux path portions to one side of the permanent magnet, which the open magnetic circuit can be closed by a magnetically attractive plate placed across the center and outer pole pieces, whereby the alternating magnetic flux produces a force alternately on attractive plates to either side of the electromagnetic device.

13. The electromagnetic device as set forth in claim 1 and claim 2, wherein linear or bi-linear motion is produced including means to vary the magnetic flux generated in the pole pieces.

14. The electromagnetic device as set forth in claim 1, wherein additional force mechanism are added to aid in the amount of travel or force produced by the device.

15. The electromagnetic device as set forth in claim 1 and claim 2, wherein the magnetic flux from one or more radially poled permanent magnet can be controlled.

16. The electromagnetic device as set forth in claims 1-14 having reduced energy requirement over prior art.

17. The electromagnetic device as set forth in claims 1-14 incorporated into a valve for the control of gases and fluids.

18. The electromagnetic device as set forth in claims 1-14 incorporated into a reciprocating pump for pumping or pressurizing gases or fluids.

19. The electromagnetic device as set forth in claims 1-14 incorporated into an electrical relay.

20. The electromagnetic device as set forth in claims 1-14 incorporated into a cryo-cooler to pump gases for producing refrigerated environments.

21. The electromagnetic device as set forth in claims 1-14 incorporated into an actuator for various mechanical actuating applications.

22. The electromagnetic device as set forth in claims 1-14 incorporated into a magnetic latch to hold various hardware in place.
